(19) United States
(12) Patent Application Publication
(10) Pub. No.: US 2024/0327264 A1
(43) Pub. Date: Oct. 3, 2024

(54) ACIDIC WASTEWATER PH NEUTRALIZATION WITH MICRONIZED CALCIUM CARBONATE

(71) Applicant: CHEMTREAT, INC., Glen Allen, VA (US)

(72) Inventor: Mostafa JAHANIAN, Woodland Hills, CA (US)

(73) Assignee: CHEMTREAT, INC., Glen Allen, VA (US)

(21) Appl. No.: 18/618,495

(22) Filed: Mar. 27, 2024

Related U.S. Application Data
(60) Provisional application No. 63/455,323, filed on Mar. 29, 2023.

(51) Int. Cl. C02F 9/00; C02F 1/50; C02F 1/54; C02F 1/56; C02F 1/66; C02F 1/74; C02F 103/16

(52) U.S. Cl. CPC C02F 9/00; C02F 1/50; C02F 1/54; C02F 1/56; C02F 1/66; C02F 1/74; C02F 2103/16; C02F 2209/06; C02F 2303/04

(57) ABSTRACT

A method for treating acidic water in an industrial processing system that has a pH of less than 5. The method includes treating the acidic water with a chemical treatment comprising micronized calcium carbonate in order to react an acid in the acidic water and the micronized calcium carbonate, and aerating the treated water to facilitate the chemical reaction so to raise the pH of the aerated water to a target pH of 5.5 or more.

### CROSS-REFERENCE TO RELATED APPLICATIONS

This application claims the benefit of U.S. Provisional Application No. 63/455,323, filed Mar. 29, 2023.

### TECHNICAL FIELD

This application relates to methods for treating acidic wastewater in industrial processing systems such as pickling lines in steel-making systems.

### BACKGROUND

Pickling is a process used in steel-making to remove impurities and oxide layers from the surface of steel. It is an important step in the production of high-quality steel products, as it helps to ensure that the final product has the desired properties, such as corrosion resistance, strength, and ductility. The process involves soaking the steel in a solution of a strong acid, e.g., hydrochloric acid or sulfuric acid, which reacts with the surface of the steel and dissolves any impurities or oxides present. The pickling process is usually carried out after the steel has been hot rolled, and before it is further processed into other products such as cold-rolled sheets, galvanized sheets, or wire. Pickling improves the surface quality of the steel, making it smoother, cleaner, and more uniform. After pickling, the steel is usually rinsed with water to remove any remaining acid, and then coated with a thin layer of oil or other protective material to prevent rusting.

Rinsing the steel with water generates wastewater (i.e., spent liquor) that is highly acidic (about pH 1.5) and contains high concentrations of heavy metals, such as iron, zinc, and chromium. This wastewater must be treated before it can be discharged into the environment to prevent harm to aquatic life and the surrounding ecosystem (water having a pH of 6 or less is heavily regulated). The treatment of acidic wastewater typically involves several steps, including neutralization, precipitation, and sedimentation. The first step is to neutralize the acidic wastewater with a base to raise the pH and reduce the acidity. The neutralization process also converts the metal ions in the wastewater to their insoluble hydroxide forms. The next step is precipitation, where metal hydroxides are allowed to settle out of the wastewater as a solid precipitate. The precipitate is then removed from the wastewater using sedimentation or filtration techniques. After the wastewater has been treated, it is typically discharged into the environment or reused within the steel-making process. In some cases, the precipitated metals may be recovered from the wastewater and reused in other processes or sold as valuable byproducts. The wastewater may also be treated with chemicals such as coagulants and flocculants to enhance the settling of the precipitate and improve the overall efficiency of the treatment process. Overall, acidic wastewater treatment is a critical step in ensuring the sustainability and environmental responsibility in applicable industries.

Conventionally, lime sludge, lime, and caustic have all been used to neutralize acidic wastewaters to raise the pH and reduce acidity. Lime sludge, in particular, is easy to access in the U.S. as a byproduct of coal lime softening. But the reaction with lime sludge lacks efficiency. And with lime, reaction time is difficult to control. Lime is also a poor buffer, i.e., the pH of wastewater treated with conventional lime methods often far exceeds 7.5 which results in overdosing that is undesirable for the environment. Caustic is hazardous for the environment.

Limestone, i.e., calcium carbonate (CaCO₃) has been considered in some cases. See “Limestone Treatment of Rinse Waters from Hydrochloric Acid Pickling of Steel”, Clean Water, Water Pollution Control Research Series, February 1971. Calcium carbonate is typically used as fibers or fillers in paper mill applications, and is also used in polymer manufacturing and in pigment/painting production. However, calcium carbonate was deemed ineffective. In Clean Water, aeration was even tested as a mechanism for facilitating the reaction. But results were still inconclusive. The calcium carbonate was ineffective for raising the pH above 7.5 making it not feasible for scavenging metals such as Zn that require more basic environments. Therefore, there is still a need for better pH neutralization techniques in acidic wastewater lines.

### SUMMARY

These and other issues are addressed by the present disclosure. In particular, it is an object of the disclosed embodiments to provide acidic wastewater treatment methods that improve cost, increase safety, and reduce negative environmental impact, e.g., less greenhouse gas. To this end, disclosed methods apply micronized calcium carbonate along with aeration techniques in novel application methods with surprising improvement in cost, safety, and reduced environmental harm. Compared to conventional lime applications, chemical treatment methods using micronized calcium carbonate produce in a range of 5 to 10× less carbon footprint. Moreover, calcining calcium carbonate into lime requires significant energy. Disclosed methods do away with this requirement by using micronized calcium carbonate directly in application methods.

In an embodiment, there is provided a method for treating acidic water in an industrial processing system that has a pH of less than 5. The method includes treating the acidic water with a chemical treatment comprising micronized calcium carbonate in order to react an acid in the acidic water and the micronized calcium carbonate, and aerating the treated water to facilitate the chemical reaction so to raise the pH of the aerated water to a target pH of 5.5 or more.

### BRIEF DESCRIPTION OF THE DRAWINGS

FIG. 1 is schematic illustration of an acidic wastewater line according to an embodiment.

### DETAILED DESCRIPTION

### Overview

Embodiments apply the discovery of improved methods of treating acidic water in industrial processing systems including, but not limited to, cast iron and steel-making (carbon or stainless) systems, acid mine draining, e.g., gold and copper mines, aeration ponds of sugar mills, waste treatment plant, nut processing plants, e.g., pistachio, oil and drilling systems, coal fire power plants, desulfurization plants, and the like. Disclosed embodiments will be described with respect to an acidic wastewater line in a steel-making system. However, it will be understood that the disclosure is not intended to be limited to this specific embodiment.

The inventors found that optimizing chemical treatments including micronized calcium carbonate in combination with aeration techniques is critical in arriving at optimal buffering capacity, i.e., pH balance, and reaction time. Disclosed methods resulted in improved cost, safety, and reduction environmental harm.

Calcium carbonate reacts with the acid (e.g., HCl) in acidic wastewater according to the following reaction (I):

2HCl+CaCO₃→CaCl₂)+H₂O+CO₂ (I)

The inventors found that the particle size of lime sludge (about 16 microns) and conventional calcium carbonate (about 7 microns) were too large for this reaction to proceed efficiently. That is, reaction (I) reaction may be too slow for many commercial applications. The inventors found that micronized calcium carbonate reacts with the acid in the acidic wastewater according to reaction (II) and proceeds at a much faster rate due to the micronized particles.

2HCl+mCaCO₃→CaCl₂)+H₂O+CO₂ (II)

However, reaction (II) will still only proceed in water up to about pH 5. The inventors unexpectedly found using that using active aeration according to reaction (III) as a catalyst sped up the reaction.

2HCl+mCaCO₃+air→CaCl₂)+H₂O+CO₂ (III)

Aeration is an important step in the disclosed methods, because it allows this reaction to progress more efficiently and up to about pH 6 to 7. Aeration speeds up this reaction by introducing air and allowing the CO₂ to escape and enter the surrounding air. Aeration increases the concentration of oxygen while decreasing the concentration of carbon dioxide.

### System

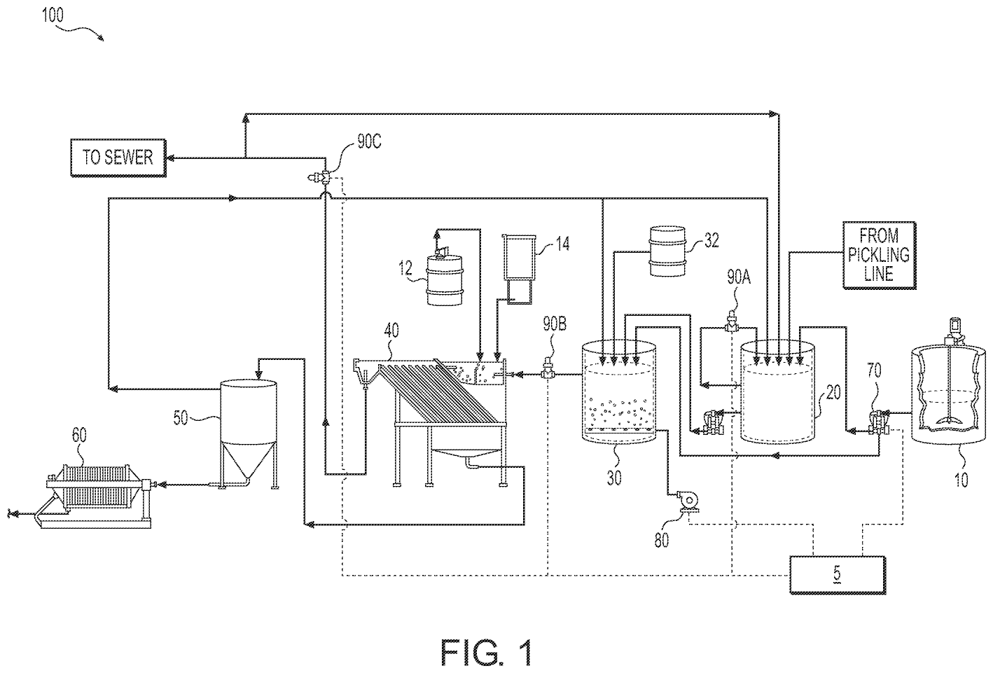

A wastewater treatment system 100 for processing acidic wastewater according to embodiments is illustrated in FIG. 1. For purposes of this example, system 100 is illustrated with respect to a wastewater line in a steel-making system. System 100 may include an equalization (receiving) tank 20. This is the initial stage of the pickling process, where the wastewater from the pickling line is collected in the equalization tank 20. The tank is typically made of acid-resistant materials and is designed to withstand the corrosive nature of the pickling process. A storage tank 10 stores the chemical treatment including the micronized calcium carbonate and is dosed into the equalization tank 20 via dosing pump 70.

Treated wastewater from the equalization tank 20 flows into the oxidation tank 30. Oxidation tank 30 is designed to remove dissolved heavy metals from the wastewater. The oxidation tank 30 may be equipped with an agitator (not shown) that mixes the wastewater with an oxidizing agent dispensed from storage tank 32. The oxidizing agent may include, but is not limited to, hydrogen peroxide or sodium hypochlorite. The oxidizing agent helps to convert the heavy metals into insoluble metal hydroxides. Aerator 80 is also provided to supply air to the oxidation tank 30. Aerator 80 may be, for example, and air blower. Dosing pump 70 may also dose the chemical treatment into the oxidation tank 30, as shown in FIG. 1.

Treated and oxidized wastewater from the oxidation tank 30 flows into the clarifier 40. The clarifier 40 is used to separate the solid particles, including the heavy metal hydroxides, from the wastewater. The wastewater is allowed to settle in the clarifier 40, and the solids are collected at the bottom. Liquids from the clarifier 40 flow either out of the system to, for example, sewer, or are recirculated back to the equalization tank 20 for reprocessing, as shown in FIG. 1.

One or more storage tanks may be additionally provided for storing additional chemicals to be added to the clarifier 40. For example, storage tank 12 may store a metal scavenger such as, for example, sodium dimethyldithiocarbamate or an organic sulfide complex, to facilitate precipitation of the solids in the clarifier 40. Storage tank 14 may store a flocculent such as, for example, a polymer flocculent, to facilitate separation of the liquids and solids in the clarifier 40.

As seen in FIG. 1, the sludge tank 50 is used to further concentrate the collected solids from the clarifier 40. The sludge tank 50 uses gravity to separate the water from the solids, resulting in a thick sludge. The water flows back into the system 100, as shown in FIG. 1. A filter press 60 receives solids or sludge from the sludge tank 50. The filter press 60 uses pressure to remove the remaining water from the sludge, resulting in a dry cake.

As seen in FIG. 1, pH sensors 90A, 90B, and 90C are also provided. Sensor 90A is configured to measure a pH of the wastewater in the equalization tank 20. Sensor 90B is configured to measure a pH of the wastewater flowing from the oxidation tank 30. Sensor 90C is configured to measure a pH of the wastewater flowing from the clarifier 40.

The system 100 may also include a distributed control system (DCS) controller 5. Using the methods described herein, chemical treatments are able to be controlled, i.e., adjusted and optimized, while the system is online, thereby increasing overall efficiency and reducing costs. According to embodiments, chemical treatment feed rates can be precisely and accurately controlled via controller 5 which controls the dosing of the dosing pump 70. The controller is configured to input pH measurements from the sensors 90A, 90B, and 90C, determine an appropriate dosage treatment plan based on the measurements, and execute the treatment plan via the dosing pump 70. The controller 5 is also configured to control dispensing of the additional chemicals from the storage tanks 12 and 14. The controller 5 thus operates a feedback cycle which ensures the proper amount of chemical treatment is added to prevent the occurrence of unreacted calcium carbonate due to the pH getting out of control. The controller can include at least one processor, such as a CPU.

The treatment plan may include a dosage and rate control plan for the application of the chemical treatments that will be dependent upon the specific contents of the chemical treatments, the control plan and system operating conditions. According to the disclosed methods, the dosage amounts and rates can be developed for each chemical treatment applied, to thereby allow for the change in dosage amounts and rates.

It will be understood that the above-described control feed architecture may include other circulation pumps and chemical treatment pumps (not shown) in order to accommodate required volumes of wastewater and chemical treatment running through the system 100. The controller 5 may control the operation of these pumps based on demand driven by various system parameters, e.g., operational load. The controller 5 controls the overall operation of the facility and is where the plant instrumentation sends its data, and may include, for example, tens of thousands of data points. The architecture may further include a data capture panel for receiving operations input and providing the controller 5 with the appropriate instructions for controlling the operation of the pumps.

The proper chemical treatment dosage and rate can be adjusted real-time using recorded parameters. Once the dosage amounts and rates are calculated, these schemes may be stored in the storage for historical purposes. The schemes are then accessed by the controller 5 when appropriate and applied to the system 100 via the control feed architecture. The control feed architecture adjusts the amount and/or rate of the chemical treatment by, for example, calculating the ml/min set point to control and adjust the various chemical feed pumps to control flow from the storage tanks. The dosage schemes for each specific chemical treatment are optimized in this manner.

Additionally, the programmable logic behind the dosing and application rate can be refined in the field in response to real-time real-world conditions and performance at the site. And adjustments to dosing and application rate can be made virtually instantaneously. As a result, the disclosed embodiments will provide real-time and more effective control management compared to conventional processes by improving the overall reliability, efficiency, and economic productivity of the system 100.

Embodiments may further include machine learning algorithms implemented on the disclosed controllers for executing the disclosed functions in a predictive manner. For example, the machine learning algorithms may be used to establish historical patterns to predict future feed needs based on any one or more parameters that may include. Outputs of the predictive logic controllers may be connected to external reporting and analysis sites such as an inventory control device.

### [Methods of Treatment]

Disclosed methods include treating acidic wastewater in an industrial processing system. The acidic water may have a pH of less than 5, in a range 1 to 4, 1.5 to 3, 1.5 to 2, or about 1.5.

The methods include a step of treating the acidic water with a chemical treatment comprising micronized calcium carbonate in order to react an acid in the acidic water and the micronized calcium carbonate. The chemical treatment may be added in the equalization tank 20, the oxidation tank 30, or both. The method includes providing the chemical treatment comprising the micronized calcium carbonate disclosed herein. The chemical treatment may be added in sufficient to amount raise the pH to a value in a range of 1 to 6, 1 to 5, 2 to 6, 2.5 to 5.5, 3 to 5.5, 3.5 to 5.5, 4 to 5, 4.5 to 5, or preferably about 5. For example, the chemical treatment may be added so that a concentration of the micronized calcium carbonate in the acidic water is in a range of 1 to 50,000 ppm, 10 to 10,000, 100 to 10,000, 10 to 5,000 ppm, 100 to 1,000 ppm, or 100 to 500 ppm.

The method includes a step of aerating the treated water to facilitate the chemical reaction so to raise the pH of the aerated water to a target pH. Acidic water flowing from the equalization tank 20 to the oxidation tank 30 is aerated in the tank 30 to facilitate removal of CO₂. This step raises the pH of the acidic water to the target pH in a range 5.5 to 7.5, 5.5 to 7, 6 to 7, 6.5 to 7, or preferably about 6.5. In embodiments, the aeration step includes “active” aeration, which will be understood to be different from “passive” aeration resulting from incidental exposure to atmospheric air or other passive air stream. As discussed above, the aeration step may be performed by an aerator or blower. Any suitable velocity of the air stream supplied by the aerator is contemplated herein. For example, the air stream may be supplied at 1 to 20 mph, 1 to 10 mph, or 2 to 5 mph. The air velocity may depend or be optimized based on a desired reaction speed or system environment. Moreover, the quantity of the air applied may depend on the generated CO₂, and the temperature may be based on user, system, and/or environmental parameters.

The wastewater then flows to the clarifier 40 where a metal scavenger and/or flocculent may be added. Finally, the neutralized wastewater either exits the system 100 or is recirculated back to the equalization tank 20.

### [Treatment Composition]

Disclosed chemical treatments include micronized calcium carbonate. These treatments effectively raise the pH of the acidic wastewater to about 5. Then, in combination with aeration, to an optimal level of 6 to 7, or about 6.5, discussed above. The chemical treatment may include micronized calcium carbonate in slurry or powder form. The treatment composition may include micronized calcium carbonate in any suitable amount. For example, chemical treatment may include micronized calcium carbonate in a range of 50% to 100%, 50% to 99%, 60% to 90%, or 75% to 85% by wt % in slurry or powder form. In embodiments, the chemical treatment may include micronized calcium carbonate in a range of 70% to 75% by wt % in slurry or 92 to 99% in powder form.

Micronized calcium carbonate refers to calcium carbonate having a maximum particle size within a specified range. Maximum particle size may be determined according to any suitable method known in the art. For example, maximum particle size may be determined using a particle mesh method. In embodiments, the micronized calcium carbonate may have a maximum particle size in a range of 0.01 to 5 microns, 0.1 to 3 microns, 1 to 2 microns, 1 to 1.5 microns, or preferably about 1.5 microns. In other embodiments, the micronized calcium carbonate may have a maximum particle size in a range of 0.01 to 4 microns.

The treatment composition may include other additives including, but not limited to, dispersants and/or biocides in suitable residual amounts. These residuals may be present in the chemical treatment collectively in a range of 0% to 50%, 1% to 50%, 10% to 40%, or 15% to 25% by wt %. In embodiments, these residuals may be present in the chemical treatment collectively in a range of 0% to 25% by wt %.

It will be appreciated that the above-disclosed features and functions, or alternatives thereof, may be desirably combined into different systems or methods. Also, various alternatives, modifications, variations or improvements may be subsequently made by those skilled in the art. As such, various changes may be made without departing from the spirit and scope of this disclosure.

What is claimed is:

1. A method for treating acidic water in an industrial processing system that has a pH of less than 5, the method comprising:
treating the acidic water with a chemical treatment comprising micronized calcium carbonate in order to react an acid in the acidic water and the micronized calcium carbonate; and
aerating the treated water to facilitate the chemical reaction so to raise the pH of the aerated water to a target pH of 5.5 or more.

2. The method according to claim 1, wherein the target pH of the aerated water is in a range of 6.0 to 7.5.

3. The method according to claim 1, wherein the target pH of the aerated water is in a range of 6.0 to 7.0.

4. The method according to claim 1, wherein the target pH of the aerated water is in a range of 6.5 to 7.0.

5. The method according to claim 1, wherein the micronized calcium carbonate has a maximum particle size of 1.5 microns.

6. The method according to claim 1, wherein a pH of the acidic water is in a range of 1 to 4.

7. The method according to claim 1, wherein a pH of the treated water is in a range of more than 4 to 5.

8. The method according to claim 1, wherein the chemical treatment is introduced as a slurry.

9. The method according to claim 1, wherein the chemical treatment is introduced as a powder.

10. The method according to claim 1, wherein an amount of the micronized calcium carbonate in the chemical treatment is in a range of 50% to 99%.

11. The method according to claim 1, wherein an amount of the micronized calcium carbonate in the chemical treatment is in a range of 75% to 85%.

12. The method according to claim 1, wherein the chemical treatment further comprises at least one of a dispersant and a biocide.

13. The method according to claim 1, further comprising treating the aerated water with a metal scavenger.

14. The method according to claim 13, wherein the metal scavenger includes an organic sulfide complex.

15. The method according to claim 1, further comprising treating the aerated water with a flocculent.

16. The method according to claim 15, wherein the flocculent includes a polymeric flocculent.

17. The method according to claim 1, further comprising:
measuring a pH of at least one of the acidic water and the treated water, and
controlling the chemical reaction so that a pH of the aerated water reaches the target pH.

18. The method according to claim 17, wherein the controlling step further includes adjusting a dosing of the chemical treatment based on the measured pH to control the chemical reaction so that the pH of the aerated water reaches the target pH.

19. The method according to claim 1, wherein the industrial processing system is online.

20. The method according to claim 1, wherein the industrial processing system is a cast iron production system, a steel-making system, a metal mining system, a sugar mill system, a waste treatment system, a nut processing system, an oil and drilling system, a coal fire power system, or a desulfurization system.
